(19) United States
(12) Patent Application Publication
(10) Pub. No.: US 2005/0006190 A1
(43) Pub. Date: Jan. 13, 2005

(54) Brake control device with a check valve for a motor vehicle

(76) Inventors: Pierre Lebret, Versailles (FR); Alwin Stegmaier, Allemagne (DE)

Correspondence Address: Leo H McCormick Jr, 2112 Mishwaka Avenue, P O Box 4721, South Bend, IN, 46634-4721, US

(21) Appl. No.: 10/486,433

(22) PCT Filed: Aug. 2, 2002
(86) PCT No.: PCT/FR02/02806

(30) Foreign Application Priority Data
Aug. 8, 2001 (FR) 01/10680

(51) Int. Cl. B60T 11/00

(52) U.S. Cl. 188/347

(57) ABSTRACT

The invention relates to a brake control device comprising:
a liquid reservoir (4),
a master cylinder (2), and
a valve (14) able to allow the liquid of the cylinder in the reservoir to rise by offering a first minimum flow cross section (31).

The valve is able to allow the rise by offering a second minimum flow cross section (33) which is larger than the first cross section when a pressure in the cylinder exceeds a given threshold.

The invention relates to braking circuits, for a motor vehicle having a reservoir of brake liquid and a master cylinder.

It is known that, in a conventional vehicle braking circuit, the brakes receive the brake command in the form of a pressure of brake liquid from a master cylinder, itself supplied from a liquid reservoir. The brake command emitted by the driver in mechanical form is converted to hydraulic form by the master cylinder by means of two pistons which can move in the body of the master cylinder. Before receiving the command, the chamber intended to be compressed by each piston is in communication with the liquid reservoir through an orifice in the piston. As the piston starts to move, this orifice passes a sealing lip which means that the chamber finds itself isolated from the reservoir and that the pressure in the chamber can begin to rise. The travel of the piston as far as the start of the increase in pressure is known as the “dead travel” because it contributes nothing to braking. Attempts are therefore being made at reducing this travel as far as possible.

To this end, it was proposed that a valve formed of a disk pierced with a passage at its center be arranged between the reservoir and the master cylinder. This valve is not as dense as the liquid which means that at rest it tends to press against a seat placed above it, on the reservoir side. The disk drops automatically if the liquid drops from the reservoir toward the master cylinder. At rest, the central passage allows the liquid of the master cylinder to rise back up toward the reservoir at a low flow rate, forming a restriction. During the brake command, the movement of the piston causes a sudden and sharp increase in flow rate. Knowing that the restriction is unable to allow the liquid to rise back up quickly enough, this valve therefore essentially behaves as if the communication between the reservoir and the master cylinder were shut off. The pressure can therefore increase very rapidly in the piston chamber, even before the lip has been passed.

However, such an arrangement has disadvantages in the presence of special or improved braking circuits such as those fitted with ABS and ESP (dynamic course control), known per se. What happens is that such a device, nowadays installed on numerous vehicles, is likely to cause the liquid to flow back from the brakes to the master cylinder. The pressure then generated is very high and may be such that the valve disk breaks.

One object of the invention is to reduce the dead travel without running the risk of breaking the valve in the presence of a device of the ABS type.

To this end, the invention provides a brake control device comprising:
a liquid reservoir,
a master cylinder, and
a valve able to allow the liquid of the cylinder in the reservoir to rise by offering a first minimum flow cross section,
   the valve being able to allow the rise by offering a second minimum flow cross section which is larger than the first cross section when a pressure in the cylinder exceeds a given threshold.

Thus, the valve continues to behave essentially like a shutter when the piston begins its travel, the pressure then being relatively low and below the threshold. By contrast, in the event of a sudden reflux of liquid toward the reservoir, generating a sharp increase in pressure beyond the threshold, for example as the result of an ABS or an ESP, the second cross section allows the liquid to rise back up toward the reservoir without the risk of damaging the valve. The integrity of the valve and the short dead travel are therefore both preserved.

The device according to the invention may also exhibit at least any one of the following characteristics:
the valve comprises a seat and a shutter able to bear against the seat,
it comprises means of centering the shutter with respect to the seat,
the shutter has a density lower than that of the liquid,
the seat is rigid,
the seat can be moved with respect to the reservoir when the pressure exceeds the threshold,
the seat has at least one passage and is designed to allow the liquid to rise through the passage only when the seat moves,
it comprises means of returning the seat against the rising of the liquid,
the seat can be deformed elastically when the pressure exceeds the threshold,
the seat is deformable so that the liquid flows around or through the seat during the rise,
the seat has at least one orifice designed to be open only during deformation,
the orifice opens to one edge of the seat,
the orifice extends some distance from the edges of the seat,
it has at least one relief designed to cause the shutter to tip with respect to the seat when the pressure exceeds the threshold,
the shutter has at least one passage and is designed to allow the liquid to rise through the pipe when the shutter is in contact with the seat,
the passage passes right through the shutter,
the passage extends over one face of the shutter able to come into contact with the seat,
the shutter has one approximately spherical face able to come into contact with the seat,
the shutter is a ball,
the shutter has the overall shape of a flat cake,
the valve has an orifice via which liquid can leave toward the master cylinder and which is arranged in such a way that the shutter, in its lowermost position, leaves this orifice open,
the orifice extends in a vertical wall,
it comprises means of retaining the shutter with respect to the reservoir before the reservoir is assembled with the master cylinder, and
the valve is able to allow the liquid to drop from the reservoir into the master cylinder by offering a third minimum flow cross section which is larger than the first cross section.

The invention also provides a valve for a device for controlling a brake with a liquid reservoir and a master cylinder, the valve being able to allow liquid to rise by offering a first minimum flow cross section and able to allow the rise by offering a second minimum flow cross section which is larger than the first cross section when a liquid pressure reaches a given threshold upstream of the valve, with reference to the direction of flow during the rise.

Other characteristics and advantages of the invention will become further apparent from the following description of several embodiments which are given by way of nonlimiting examples. In the appended drawings:

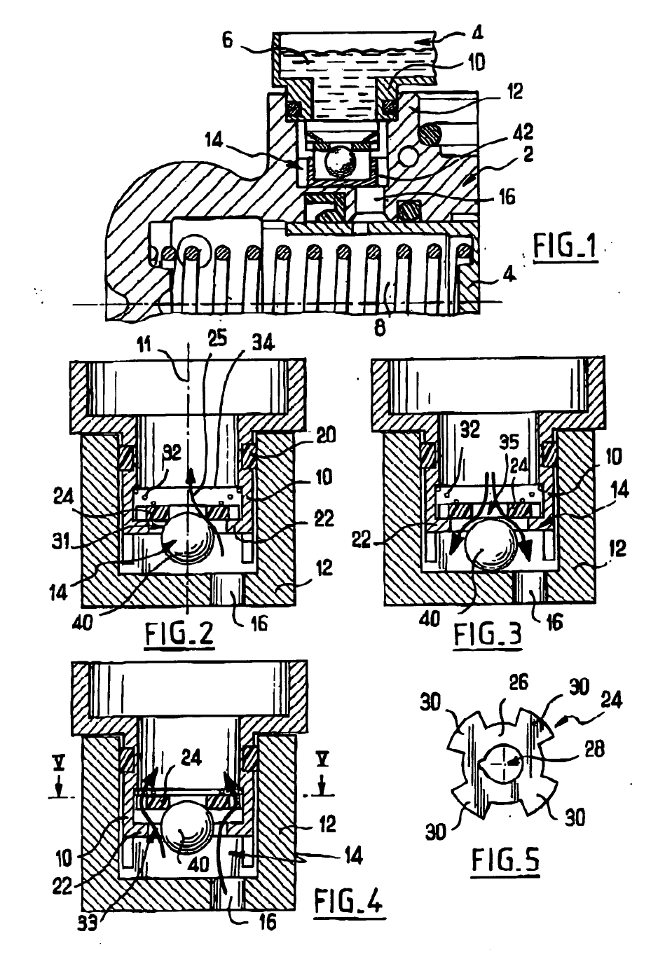

FIG. 1 is a part view of one embodiment of the device according to the invention showing the reservoir schematically, and the valve and part of the master cylinder in axial section;

FIGS. 2, 3 and 4 are three views in axial section of the valve of the device of FIG. 1, showing three respective phases of operation;

FIG. 5 is a view in section of the valve seat on V-V of FIG. 4;

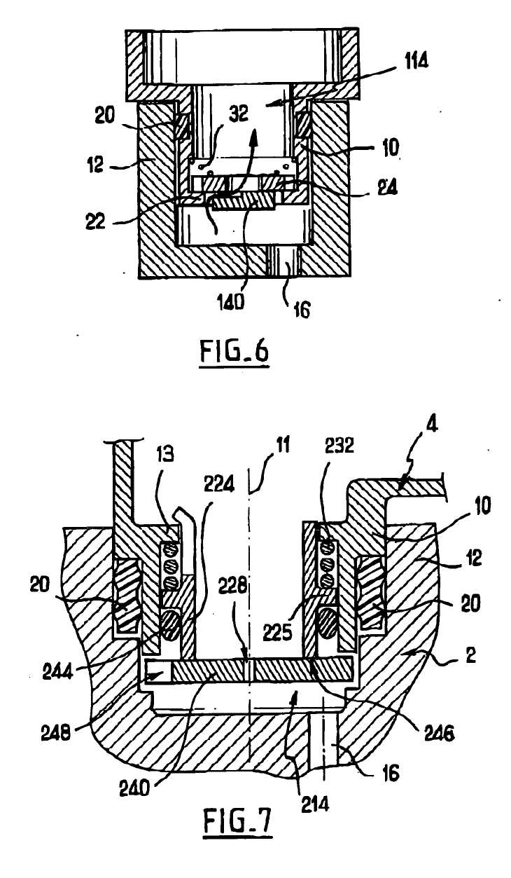

FIG. 6 is a view similar to FIG. 2, showing another embodiment;

FIGS. 7, 8 and 9 are three views in axial section similar to FIG. 2, showing three other embodiments;

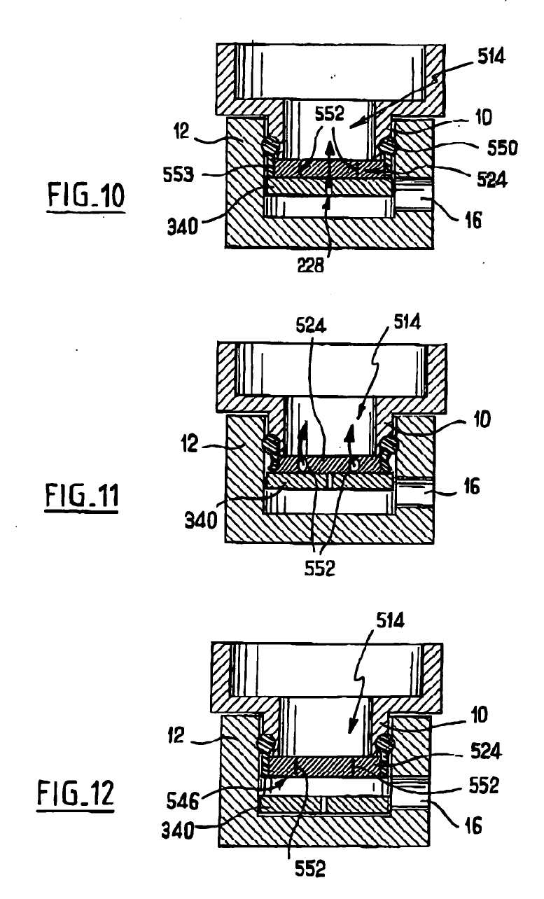

FIGS. 10, 11 and 12 are three views in axial section analogous respectively to FIGS. 2 to 4 and illustrating another embodiment of the invention;

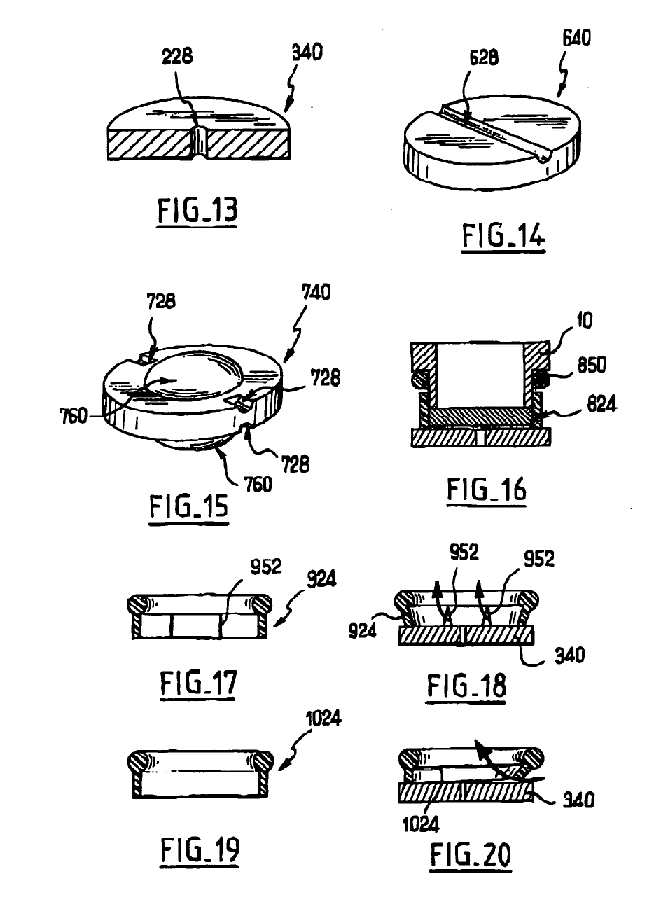

FIGS. 13 to 15 are three views in perspective and, in the case of FIG. 13, in section also, illustrating various alternative forms of embodiment of the shutter in the valve of FIG. 10;

FIG. 16 is an axial view analogous to FIG. 10, showing another alternative form of embodiment;

FIG. 17 is a view analogous to FIG. 10, showing an alternative form of embodiment of the shutter seat alone, at rest;

FIG. 18 is a view of the seat of FIG. 17 with the shutter in the case where the pressure exceeds the given threshold;

FIGS. 19 to 20 are views analogous to FIGS. 17 and 18 and illustrating another embodiment of the seat;

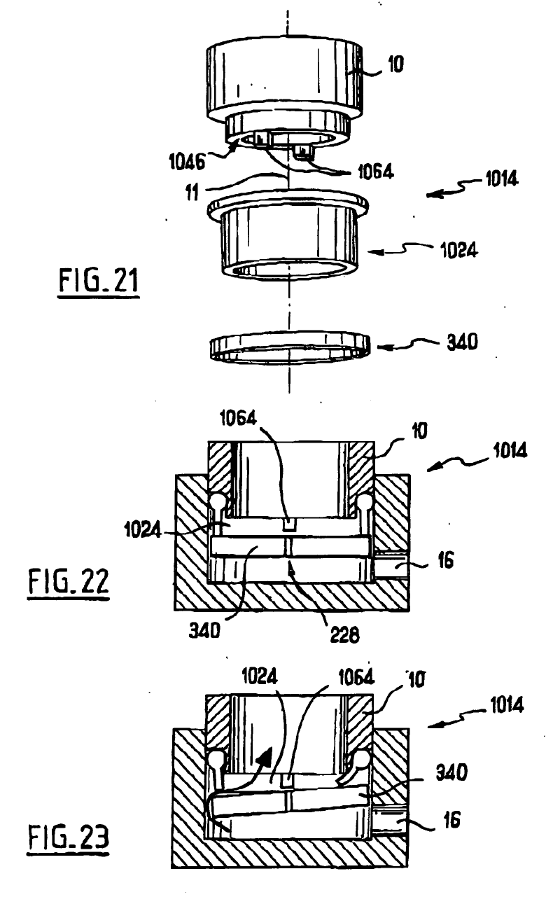

FIG. 21 is a view in exploded perspective of several parts of the valve of another embodiment of the invention;

FIGS. 22 and 23 are two views in axial section of the valve of FIG. 21 in two different states; and

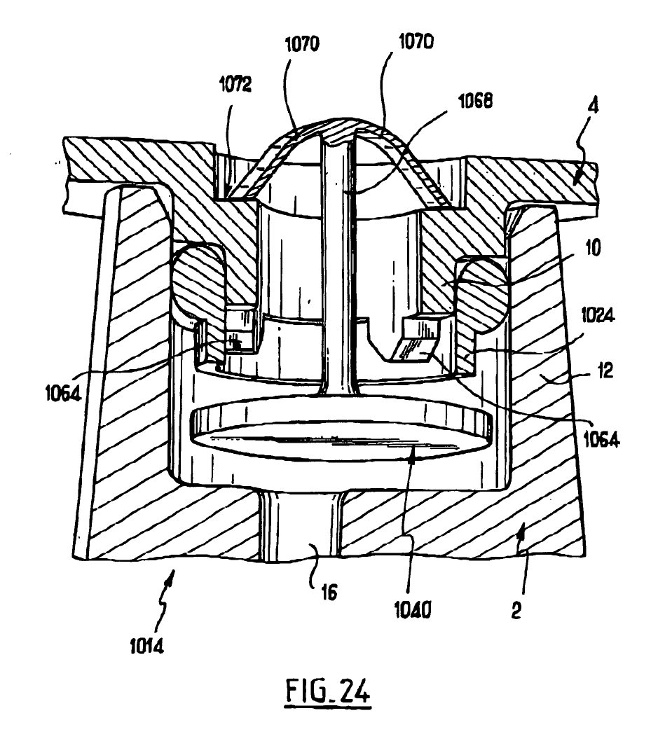

FIG. 24 is a view in axial section of another embodiment of the valve according to the invention.

A first embodiment of the brake control device according to the invention will be described with reference to FIGS. 1 to 5. This device is intended for a motor vehicle comprising a hydraulic braking circuit supplying pressurized brake liquid to disk- or drum-brakes associated respectively with the four wheels of the vehicle.

In a way known per se, the device comprises a master cylinder 2, here of the tandem type, comprising two pistons, just one, 4, of which has been illustrated, able to generate an increase in pressure in the circuit so as to transmit to the brakes a brake command originating from the driver. The device also comprises a reservoir 4 of brake liquid 6 designed to supply brake liquid to each of the two chambers 8 associated with the respective pistons 4. A single supply circuit has been illustrated in FIG. 1, but it must be understood that the device comprises, just like the devices of the prior art, two circuits allowing liquid to be supplied to each of the chambers 8 from the same reservoir 4.

The reservoir 4 is arranged above the master cylinder so as to encourage the liquid to flow under gravity from the reservoir to the master cylinder. In this particular instance, the reservoir is mounted by nesting in the master cylinder. To this end, the reservoir 4 has a cylindrical neck 10 able to be housed, with male-female engagement, in a cylindrical housing 12 of the master cylinder of a corresponding size.

The device according to the invention comprises a valve 14 arranged in a cavity of the master cylinder extending immediately under the neck 10 of the reservoir. The valve can therefore receive liquid directly from the reservoir. Under the valve, a passage 16 places the valve in direct communication with the chamber of the piston or with the piston itself, depending on the position of the latter. The device comprises a seal 20 inserted between the neck 10 and the housing 12 so as to seal against liquid at the point where these items meet, and therefore isolate the valve from atmospheric air. Naturally, given the fact that, in the embodiment depicted, the reservoir supplies the master cylinder at two points, the device according to the invention will preferably comprise two valves such as the aforementioned. It is of course conceivable for the master cylinder depicted to have just one valve, advantageously arranged in the secondary circuit as depicted in the figure.

The neck 10 has a lip 22 extending radially toward the inside of the neck with reference to a vertical central axis 11 thereof. This lip 22 is continuous right around the axis. The valve has a seat 24 illustrated in particular in FIG. 5. This seat comprises a roundel 26 which at its center has an orifice 28 and which is extended radially from its external circumference by tabs 30, in this instance four tabs, distributed uniformly around the roundel. The orifice has a circular shape interrupted by a leakage channel, such as a notch, for the passage of the liquid. The seat 24 rests on the lip 22. In this position, the ends of the tabs 30 have sliding contact with the interior face of the neck 10, which centers the roundel approximately coaxially with the neck. The outside diameter of the roundel 26 is larger than the inside diameter of the lip 22 which means that the exterior edge of the roundel bears continuously against the lip 22. The shutter 14 comprises a spiral spring 32 of conical overall shape bearing, downward, at the location of its narrowest cross section, on the upper face of the roundel 26, whereas at the top it bears against a shoulder 34 formed for that purpose in the neck 10. This spring 32 returns the seat 24 downward against the lip 22.

The valve comprises a shutter 40, in this instance consisting of a ball. This ball is made of a material known per se so that it has a density lower than that of the liquid. In that way, the ball, when immersed in the liquid, tends to rise up against the action of gravity. The ball extends under the seat 24 facing the lip 22. At rest it positions itself against the roundel 26, roughly shutting the central orifice 28 thereof.

This device operates as follows. With reference to FIG. 2, the liquid present in the master cylinder can rise freely at low pressure toward the reservoir by passing through the passage 16 then the neck 10, leaking through the notch of the orifice 8 between the shutter 40 and the seat 24 as indicated by the arrow 25.

Furthermore, if need be, the liquid present in the reservoir can flow through the passage 16 toward the master cylinder. This flow temporarily lowers the ball to some distance from the seat 24 so as to offer a larger passage cross section for the liquid.

FIG. 4 illustrates the case where, for some reason, for example because braking liquid has been sent into the master cylinder by a device of the ABS type, the pressure in the master cylinder increases sharply, for example while the latter is at rest. This pressure is therefore transmitted to the valve 14. This high pressure urges the ball 40 and the seat 24 against the action of the spring 32, which means that the spring is compressed and that the seat and the shutter rise as one. Under these conditions, a large passage cross section is available for the liquid on the one hand between the shutter 40 and the lip 22 and, on the other hand, between the tabs 30.

In the situation of FIG. 2, the smaller flow cross section 31 which we shall here term the first minimum cross section is defined between the shutter 40 and the seat 24 by the notch of the orifice 28. In the situation of FIG. 4, the smallest flow cross section 33, which we shall call the second minimum cross section, is defined between the shutter 40 and the lip 22 and between the tabs 30. This second minimum cross section 33 is larger than the first minimum cross section 31. The configuration of the device determines a threshold such that, when the pressure is below this threshold, the rise of liquid occurs in the configuration of FIG. 2, whereas, when this pressure exceeds the threshold, this rise occurs according to the configuration of FIG. 4. This threshold depends to a large extent on the load of the spring 32. It will be easy to configure the device and in particular to calibrate the spring so as to set the given pressure threshold to the desired value. In the configuration of FIG. 3, the flow of liquid takes place through a minimum cross section 35 which we shall here term the third minimum cross section and which is defined by the orifice 28 of the seat. This cross section 35 is larger than the first cross section 31 associated with FIG. 2.

As an alternative, as illustrated in FIG. 1, is it possible to envisage for the valve to comprise a grating or a filter 42 extending downward from the lip 22 and enclosing the shutter 40 by lying some distance from the passage 16. Such an element makes it possible to ensure that under no circumstance will the shutter shut off the passage 16 leading to the master cylinder, and to facilitate assembly.

An alternative form of embodiment of the device has been illustrated in FIG. 6 with certain numerical references increased by 100. The only difference between this embodiment and the previous one lies in the fact that the shutter 140 is this time configured in the form of a disk having, on its upper face, a shoulder or a channel cutting into this face over about 90 or 180°. The diameter of the shutter 140 is greater than the diameter of the central orifice 28 in the seat 24.

This embodiment works appreciably like the previous one. At rest, the shutter 140 bears from underneath against the seat 24. Given that the orifice 28 of the seat is not completely shut off by the stepped upper face, it is always possible for liquid to rise at low pressure, the liquid passing between the shutter and the seat at the shoulder. When the pressure exceeds the given threshold, the seat and the shutter move upward, compressing the spring 32, to offer a larger flow cross section. If the liquid drops from the reservoir to the master cylinder, the shutter 140 can lower to allow the liquid to flow through the orifice 28 with a larger cross section than in the case of the low-pressure rise.

Another embodiment has been illustrated in FIG. 7. In this embodiment, as in the previous ones, the neck 10 of the reservoir is nested in the housing 12 of the master cylinder with the insertion of a seal 20 while the transverse profile thereof here differs from that of FIG. 2. Specifically, the profile of the seal here has two lateral bulges, one above the other. The seat 224 in this particular instance has a cylindrical overall shape of axis 11. It comprises a lip 225 extending radially toward the outside with reference to the axis 11. The neck 10 itself comprises a lip 13 extending radially toward the inside with reference to the axis 11 at the upper part of the neck. The spring 232 here has a cylindrical overall shape of axis 11 and bears upward against the underside of the lip 13 and downward against the top face of the lip 225. It therefore here again plays a part in urging the seat 224 downward. An O-ring seal 44 is inserted radially with respect to the axis 11, between the neck 10 and the seat 224, this seal extending under the lip 225. The seat 224 has an essentially flat lower axial end edge 246 extending, when the valve 240 is at rest, lower down than the lower edge of the neck 10. The shutter 240 in this particular instance has the overall shape of a flat cake or of a disk. It has, for example, at its center, a passage 228 of cylindrical shape passing through the shutter through its thickness. The shutter also has at least one notch 248 cutting into the outer edge of the shutter.

This embodiment works as follows. When the valve is at rest, the shutter 240, because of its low density, is pressed against the lower edge 246 of the seat 224. In this situation, liquid is allowed to rise up through the orifice 228 when the pressure does not exceed a given threshold.

When the pressure exceeds the threshold, this pressure urges the shutter 240 upward, and this causes the shutter to rise as one with the seat 224 until the shutter 240 is pressed against the lower edge 246 of the neck. The still high pressure is imparted, through the notch 248, to the underside of the seal 244 which is therefore urged upward. With the seat 224, the seal 244 moves upward, compressing the spring 232. The space thus created between the lower edge 246 of the seat and the shutter 240 which has remained lower down thus offers a wide cross section for the passage of high-pressure liquid. As in the previous embodiments, liquid can flow from the reservoir to the master cylinder, causing a temporary downward movement of the shutter 240 a distance from the lower edge 246 of the neck.

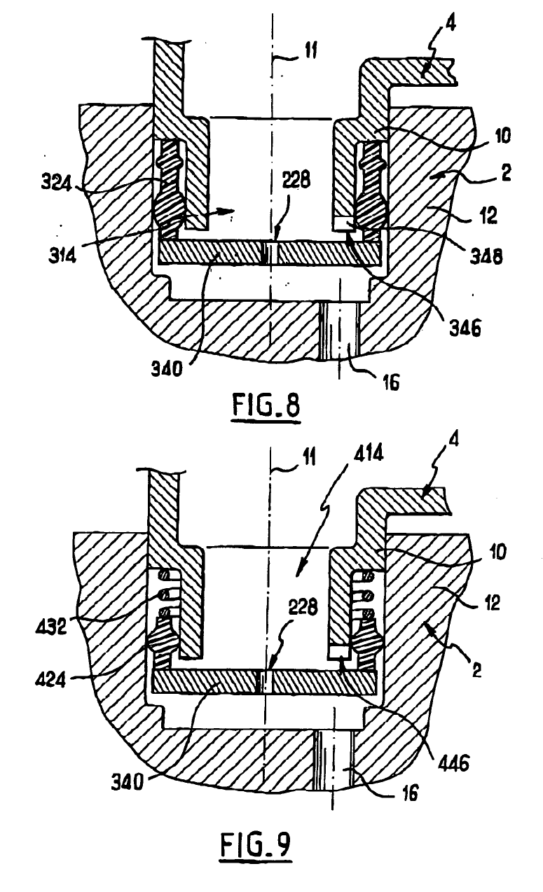

Another embodiment is illustrated in FIG. 8. The shutter 340 here again is formed of a roundel, this time with a passage 228 passing through its center. The notch from the previous embodiment is omitted this time. This shutter is also illustrated in FIG. 13. The seat 324 here is formed of a seal inserted radially with reference to the axis 11 between the neck 10 and the housing 12. The lower edge 346 of the neck 10, which lies facing the shutter 340, has at least one notch 348 on one side. The seal 324 has a profile with two superposed bulges as in the previous embodiment. Its lower end has a profile of essentially rectangular shape. It bears at the top against a shoulder of the neck 10 and at the bottom against the upper face of the shutter 340. The seal is also in sealed contact in the radial direction at the lower bulge at least with the neck 10 and the housing 12. The seat 324 keeps the shutter 340 a distance away from the lower edge 346 of the neck 10. The seal 324 is the valve seat.

In the event of liquid at low pressure rising, the liquid flows upward through the orifice 228.

When the pressure in the liquid of the master cylinder exceeds the given threshold, the shutter compresses the seal upward to tend to move it closer to the edge 346. As the pressure increases, the seal continues to deform along the axis 11 and leaves the shutter 340 which remains bearing on the neck 10. The liquid can then escape toward the reservoir via the notch 348. This notch therefore offers a larger passage cross section than the orifice 228.

The fall of liquid from the reservoir to the master cylinder takes place as before by temporary lowering of the shutter 340.

Another embodiment is illustrated in FIG. 9. It is very similar to the previous one, the upper part of the seal 424 this time being replaced by a return spring 432 bearing against the seal 424 toward the bottom and against a shoulder of the neck toward the top. Operation is practically unchanged.

Another embodiment is illustrated in FIGS. 10 to 13. The shutter 340 is once again configured as a disk, here pierced at its center with an orifice 228. As in the embodiment of FIG. 8, the seat 524 provides sealing between the neck 10 and the housing 12. In this particular instance, this seal has a toric upper part 550 providing the seal between these two parts radially with reference to the axis of the valve. The seal also has a lower skirt 553 of cylindrical shape extending downward from the toric upper part 550. It is against the lower edge of this skirt that the shutter 340 bears. The toric upper part 550 is housed in a shoulder of the neck 10 internally covering this part as far as the region facing the skirt 553. The skirt has slots 552 uniformly distributed about the axis and each running vertically over most of the height of the skirt while remaining distant from its edges. The slots pass radially through the thickness of the skirt.

Furthermore, the orifice 16 causing the valve to communicate with the master cylinder is this time formed in a side wall of the master cylinder rather than vertically in line with the shutter 340. What is more, the lower edge of this orifice extends slightly above the bottom of the cavity in which the shutter 340 moves. This orifice 16 has a diameter greater than the height of the shutter 340. This being the case, there is no position of the shutter 340 that allows it to shut off the orifice 16. This arrangement is also advantageous, if appropriate, for the other embodiments.

This embodiment works as follows. If the low-pressure liquid rises from the master cylinder, the stream of liquid flows through the central orifice 228 as illustrated in FIG. 10, the shutter 540 remaining pressed against the seat 524. The slots 552 are then closed. When, on the other hand, liquid at a pressure higher than the given threshold rises, the pressure urges the shutter upward, and this deforms the skirt 553 and thereby opens the slots 522 through which the liquid flows, which liquid therefore has a larger flow cross section available to it than the cross section, illustrated in FIG. 10, that corresponds to the passage 228 alone. When this high pressure ceases, the valve returns automatically to the configuration of FIG. 10 under the effect of the elasticity of the seat 524. Here again, a flow of liquid from the reservoir to the master cylinder is permitted by the temporary lowering of the shutter 340, the flow being over the shutter without passing under it, given the position of the orifice 16 as illustrated in FIG. 12.

FIG. 14 illustrates an alternative form of embodiment of the shutter. The shutter 640 can be used with the valve of FIG. 10. The passage here is replaced by a groove 628 extending over the upper face of the shutter and cutting into the latter from at least one circumferential edge. In this particular instance, the groove 628 extends without interruption across a diameter of this face from one edge of this face to the other. This groove 628 allows liquid to flow in order to rise in the tank at low pressure, the groove not being shut off by the upper face of the shutter bearing against the lower edge of the seat 524.

Another embodiment of the shutter 740 is illustrated in FIG. 15. In this particular instance, the groove 728 is made in two parts. Each groove part extends from one edge of the shutter toward the center thereof over sufficient length to allow the groove part to open to the center of the seat. In addition, in this embodiment, the shutter 740 has a central relief 760 extending from the upper face and having, for example, a shape of a portion of a sphere or a very similar shape. This relief 760 becomes housed at the center of the seat and thus centers the shutter with respect to the seat and, on the other side, limits the travel. In this particular instance, the shutter has a relief 760 and a two-part groove 728 on each of these two main faces which means that it is symmetric about its horizontal mid plane, thus allowing the shutter to be mounted in the valve without concern regarding the direction of fitting. The reliefs 760 contribute to the centering of the shutter with respect to the seat and to the limiting of the downward travel of the shutter, the lower relief shortening this travel by butting against the bottom of the housing of the master cylinder. Finally, by increasing the volume of the part, they encourage greater upthrust and therefore encourage the shutter to rise naturally in the liquid.

FIG. 16 shows another embodiment in which the seat 524 of FIG. 10 has been separated into two distinct parts, the cylindrical skirt this time alone forming the seat 824 while the O-ring seal 850 provides sealing between the neck 10 and the housing 12.

FIGS. 17 to 18 show another embodiment in which the slots of FIG. 11 are replaced by slots which open into the lower axial end edge of the seat 524. These slots partition the skirt into several distinct tabs able to curve independently of one another if the pressure of the liquid exceeds the given threshold. The liquid then flows between these tabs.

FIGS. 19 and 20 show an embodiment in which the shutter 1024 has no slots or orifices. This time, in the event of the liquid rising with a pressure above the given threshold, the liquid causes the seat to deform by curving it inward, and flows around the parts of the seat thus deformed, passing between the seat and the shutter.

Another embodiment is illustrated in FIGS. 21 to 23. The seat and the shutter are essentially unchanged by comparison with the embodiment of FIGS. 19 and 20. The neck 10 this time has two reliefs in the form of fingers 1064 projecting downward from the lower axial end edge 1046 of the neck. These two fingers are preferably arranged asymmetrically with respect to the axis 11 of the neck.

FIG. 22 illustrates these various elements when the valve is at rest. The lower edge of the seat 1024 in this situation extends further down than the fingers 1064. FIG. 23 illustrates the case where the pressure in the cylinder exceeds the given threshold, thereby causing the seat 1024 to deform as in the previous embodiments. What is more, this deformation as a result of the reduction in height of the seat brings the shutter into contact with the fingers 1062 and, given the asymmetric position of these, causes the shutter to tip with respect to the neck, accentuating the deformation of the seat on one side thereof. On the opposite side, a large flow cross section is thus formed between the seat and the shutter, for the rising of the liquid.

FIG. 24 illustrates an embodiment similar to that of FIGS. 21 to 23, more clearly illustrating the asymmetric position of the two fingers with respect to the axis of the neck. What is more, the shutter 1040 is here extended upward by a rod 1068 fixed to the center of the upper face of the shutter and running coaxially in the neck 10. This rod at its upper end carries a pair of studs 1070 oriented downward and inclined with respect to the rod so as to be able to bear against an upper shoulder 1072 of the neck and thereby limit the extent to which the shutter drops.

The way in which the device works is unchanged by comparison with the operation of the previous embodiment. This embodiment has the advantage that the shutter 1040 is carried captively by the neck of the reservoir until the reservoir and the master cylinder are assembled. The studs 1070 also play a part in limiting the downward travel of the shutter with respect to the seat. This being the case, it is once again possible to make the passage 16 open into the bottom of the housing 12 without the risk of its being shut off by the shutter.

In each of these embodiments, the seals may be made of elastomer. The same is true of each seat able to be deformed when the pressure exceeds the threshold, particularly when this seat also acts as a seal. This will therefore be the case of the elements 20, 24, 244, 324, 424, 524, 824, 850, 924 and 1024. The shutters may each time be made of a material which is not as dense as the liquid so that they naturally rise up to bear against the seat. The wall of the reservoir, particularly the neck, may be made of plastic. The wall of the master cylinder, particularly the housing 12, may be made of metal or some other material.

As can be seen, in each of these embodiments, the valve allows the liquid to flow freely from the reservoir to the master cylinder to supply the latter if need be. It also allows a modest rise of liquid at low pressure from the master cylinder to the reservoir. What is more, when the pressure in the master cylinder exceeds the threshold, the valve allows the liquid to rise toward the reservoir without the risk of breaking the valve under the effect of the pressure. The assembly according to the invention can therefore withstand, without difficulty, the sharp increases in pressure generated in the master cylinder by devices such as ESP systems. In each of the preceding embodiments, it will be easy for the person skilled in the art to configure the system and in particular to calibrate the seat return means, if appropriate, in order to set the given pressure threshold to the desired level. In addition, the assembly according to the invention makes it possible to keep a very short dead travel for the master cylinder piston so as to guarantee a swift transmission of the brake command. Given that the pressures generated in the master cylinder by devices of the ESP type may be a maximum of 250×10⁵ Pa, the given pressure may be set to a level of, for example, between 5 and 10×10⁵ Pa (the passages of the piston constitute a first pressure drop between the chamber of the master cylinder and the valve).

In each of these embodiments, the passage is not necessarily at the center of the shutter.

The device depicted in FIG. 1 according to the present invention comprises a master cylinder of the “expansion hole” type. However, it is perfectly conceivable for devices to be provided which comprise a master cylinder of the “valve” type, that is to say in which the chamber 8 is isolated from the reservoir by a valve equipped with a shutter and with a valve seat formed by the piston 4, the valve shutting off a passage made in the piston 4 allowing communication between the reservoir and the chamber 8 at rest.

A shutter held in place by upthrust has been described hereinabove. However, as an alternative, mechanical return means such as a spring, or even magnetic or electromagnetic return means could be provided as an alternative.

This valve can be applied to any hydraulic or pneumatic device. It may be necessary to envisage return means other than upthrust. It is, for example, possible to envisage inverting the valve and therefore employing gravity.

1. Brake control device comprising:
a liquid reservoir (4),
a master cylinder (2), and
a valve (14; 114; 214; 314; 414; 514; 1014) able to allow the liquid of the cylinder in the reservoir to rise by offering a first minimum flow cross section (31),
characterized in that the valve is able to allow the rise by offering a second minimum flow cross section (33) which is larger than the first cross section when a pressure in the cylinder exceeds a given threshold.

2. Device according to claim 1, characterized in that the valve comprises a seat (24; 224; 324; 424; 524; 824; 924; 1024) and a shutter (40; 140; 240; 340; 640; 740; 1040) able to bear against the seat.

3. Device according to claim 2, characterized in that it comprises means (40; 760) of centering the shutter with respect to the seat.

4. Device according to either claim 3, characterized in that the shutter has a density lower than that of the liquid.

5. Device according to claim 4, characterized in that the seat (24; 224) is rigid.

6. Device according to claim 5, characterized in that the seat (24; 224; 424) can be moved with respect to the reservoir when the pressure exceeds the threshold.

7. Device according to claim 6, characterized in that the seat (24; 524; 924) has at least one passage (552; 952) and is designed to allow the liquid to rise through the passage only when the seat moves.

8. Device according to claim 7, characterized in that it comprises means (32; 232; 432) of returning the seat against the rising of the liquid.

9. Device according to claim 8, characterized in that the seat (324; 424; 524; 824; 924; 1024) can be deformed elastically when the pressure exceeds the threshold.

10. Device according to claim 9, characterized in that the seat (324; 424; 824; 1024) is deformable so that the liquid flows around the seat during the rise.

11. Device according to claim 10, characterized in that the seat (524; 924) is deformable so that the liquid flows through the seat during the rise.

12. Device according to claim 11, characterized in that the seat (524; 924) has at least one orifice (552; 952) designed to be open only during deformation.

13. Device according to claim 12, characterized in that the orifice (952) opens to one edge of the seat.

14. Device according to claim 13, characterized in that the orifice (552) extends some distance from the edges of the seat.

15. Device according to claim 14, characterized in that it has at least one relief (1064) designed to cause the shutter (1040) to tip with respect to the seat (1024) when the pressure exceeds the threshold.

16. Device according to claim 15, characterized in that the shutter (340; 640; 740) has at least one passage (228; 628; 728) and is designed to allow the liquid to rise through the pipe when the shutter is in contact with the seat.

17. Device according to claim 16, characterized in that the passage (228) passes right through the shutter (340).

18. Device according to claim 17, characterized in that the passage (328; 728) extends over one face of the shutter able to come into contact with the seat.

19. Device according to claim 18, characterized in that the shutter (40) has one approximately spherical face able to come into contact with the seat.

20. Device according to claim 19, characterized in that the shutter is a ball (40).

21. Device according to claim 19, characterized in that the shutter (140; 240; 340; 640) has the overall shape of a flat cake.

22. Device according to claim 21, characterized in that the valve has an orifice (16) via which liquid can leave toward the master cylinder (2) and which is arranged in such a way that the shutter, in its lowermost position, leaves this orifice open.

23. Device according to claim 22, characterized in that the orifice (16) extends in a vertical wall.

24. Device according to claim 23, characterized in that it comprises means (1070) of retaining the shutter (1040) with respect to the reservoir (4) before the reservoir is assembled with the master cylinder (2).

25. Device according to claim 24, characterized in that the valve is able to allow the liquid to drop from the reservoir into the master cylinder by offering a third minimum flow cross section (35) which is larger than the first cross section (31).

26. Valve for a device for controlling a brake with a liquid reservoir and a master cylinder, the valve being able to allow liquid to rise by offering a first minimum flow cross section (31), characterized in that the valve is able to allow the rise by offering a second minimum flow cross section (33) which is larger than the first cross section when a liquid pressure reaches a given threshold upstream of the valve, with reference to the direction of flow during the rise.
